(19) United States
(12) Patent Application Publication
(10) Pub. No.: US 2025/0183591 A1
(43) Pub. Date: Jun. 5, 2025

(54) CONNECTOR

(71) Applicant: Yazaki Corporation, Tokyo (JP)

(72) Inventor: Tsubasa Kawai, Shizuoka (JP)

(73) Assignee: Yazaki Corporation, Tokyo (JP)

(21) Appl. No.: 18/960,223

(22) Filed: Nov. 26, 2024

(30) Foreign Application Priority Data
Dec. 4, 2023 (JP) 2023-204408

(51) Int. Cl. H01R 13/64

(52) U.S. Cl. CPC H01R 13/64

(57) ABSTRACT

A connector includes: a first housing provided with a plurality of first arrangement portions in which a plurality of first terminals are arranged; and a second housing fitted into the first housing and provided with a second arrangement portion, which is provided less in number than the plurality of first arrangement portions, in which a second terminal to be electrically connected to the first terminal is arranged, and the first housing and the second housing are provided with a restriction portion which enables the first housing and the second housing to be fitted in a state in which the second arrangement portion is arranged in a regular position with respect to the plurality of first arrangement portions.

### CROSS-REFERENCE TO RELATED APPLICATIONS

The present application is based on, and claims priority from the Japanese Patent Application No. 2023-204408, filed on Dec. 4, 2023, the whole contents of which are incorporated herein by reference.

### TECHNICAL FIELD

The present disclosure relates to a connector.

### BACKGROUND

Conventionally, a connector includes a first housing provided with a plurality of first arrangement portions in which tabs serving as a plurality of first terminals are arranged. Further, there has been known a connector including a second housing fitted into the first housing and provided with a second arrangement portion in which a second terminal to be electrically connected to the tab is arranged (JP 2017-208164 A). In such a connector, the number of second terminals accommodated in the connector is less than the number of tabs accommodated in the first housing. Therefore, the number of first arrangement portions of the first housing is greater than the number of second arrangement portions of the connector, and thus the second housing can be fitted into the first housing at a free position.

### SUMMARY OF THE INVENTION

However, in the connector disclosed in JP 2017-208164 A, there is a possibility that the second housing is fitted into the first housing at a different position. If the second housing is fitted into the first housing at a different position, a different first terminal and a different second terminal are electrically connected to each other.

The present disclosure has been made in view of such problems of the related art. An object of the present disclosure is to provide a connector capable of fitting a second housing into a first housing in a regular position.

A connector according to the present embodiment includes: a first housing provided with a plurality of first arrangement portions in which a plurality of first terminals are arranged; and a second housing fitted into the first housing and provided with a second arrangement portion, which is provided less in number than the plurality of first arrangement portions, in which a second terminal to be electrically connected to the first terminal is arranged, in which the first housing and the second housing are provided with a restriction portion which enables the first housing and the second housing to be fitted in a state in which the second arrangement portion is arranged in a regular position with respect to the plurality of first arrangement portions.

The present disclosure makes it possible to provide a connector capable of fitting a second housing into a first housing in a regular position.

### BRIEF DESCRIPTION OF DRAWINGS

FIG. 1 is a front view of a connector according to a first embodiment.

FIG. 2 is a front view of a first housing of the connector according to the first embodiment.

FIG. 3 is a perspective view of a second housing of the connector according to the first embodiment.

FIG. 4 is a bottom view of the second housing of the connector according to the first embodiment.

FIG. 5 is a front view of the second housing of the connector according to the first embodiment before the second housing having a predetermined second arrangement portion is formed.

FIG. 6 is a front view of the connector according to the first embodiment when the second housing is not arranged in a regular position with respect to the first housing.

FIG. 7 is a front view of a connector according to a second embodiment.

FIG. 8 is a front view of a first housing of the connector according to the second embodiment.

FIG. 9 is a front view of the second housing of the connector according to the second embodiment.

FIG. 10 is a bottom view of the second housing of the connector according to the second embodiment.

FIG. 11 is a front view of the connector according to the second embodiment when the second housing is not arranged in a regular position with respect to the first housing.

FIG. 12 is a front view of the second housing of the connector according to the second embodiment before the second housing having a predetermined second arrangement portion is formed.

FIG. 13 is a front view illustrating another example of the second housing of the connector according to the first embodiment before the second housing having a predetermined second arrangement portion is formed.

FIG. 14 is a front view illustrating another example of the second housing of the connector according to the second embodiment.

FIG. 15 is a bottom view illustrating another example of the second housing of the connector according to the second embodiment.

### DETAILED DESCRIPTION OF THE INVENTION

Hereinafter, a connector according to a present embodiment will be described in detail with reference to the drawings. Note that the dimensional ratios in the drawings are exaggerated for the sake of explanation and may differ from the actual ratios.

### First Embodiment

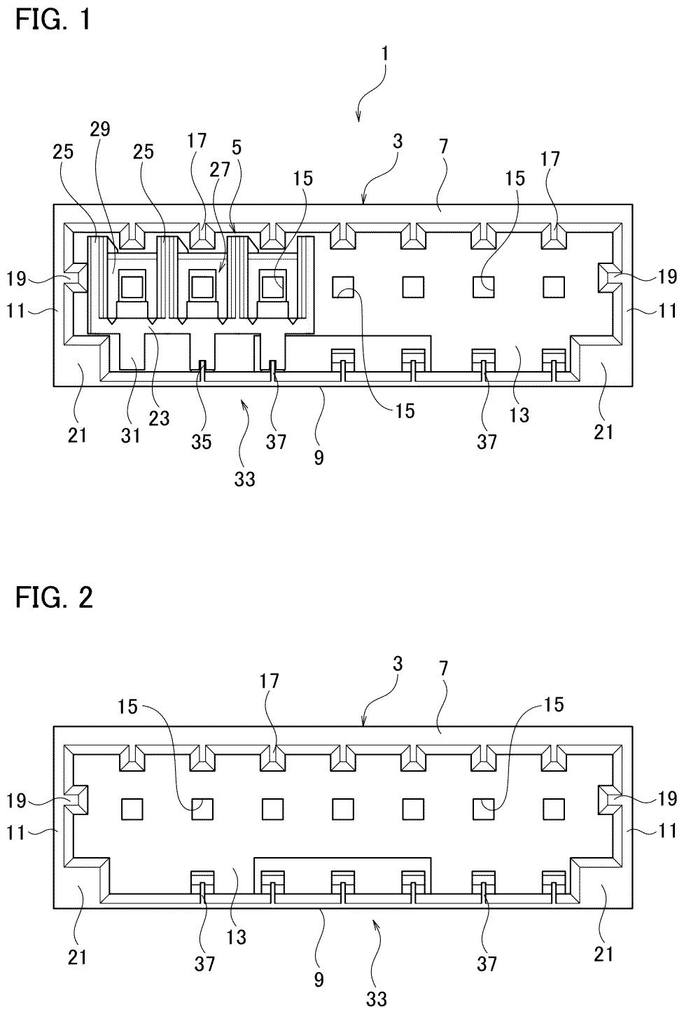

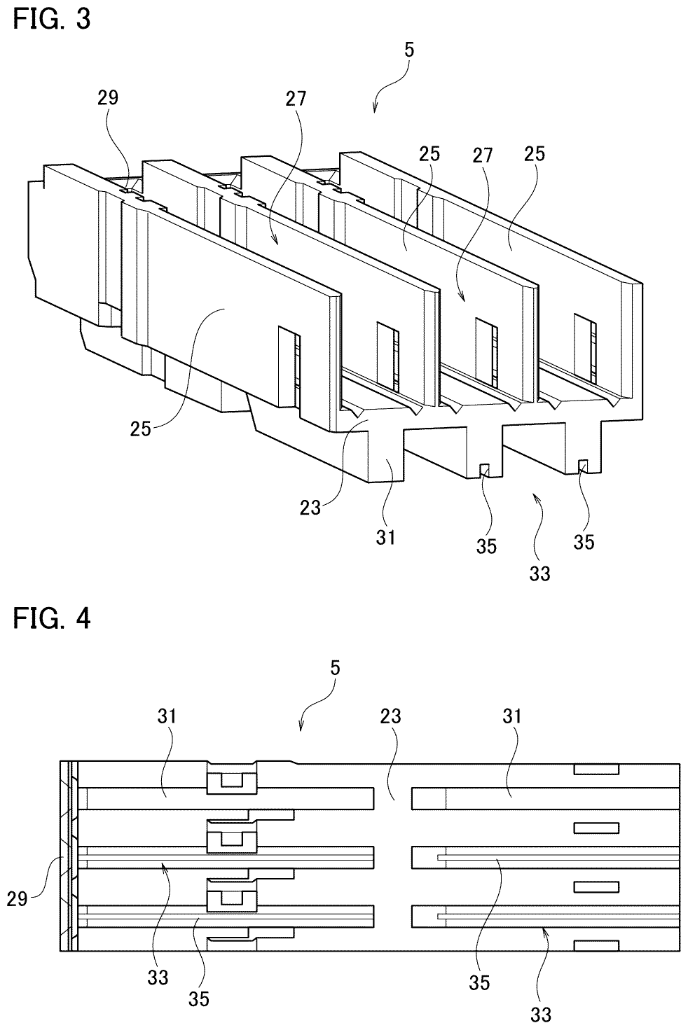

A first embodiment will be described with reference to FIGS. 1 to 6.

As illustrated in FIG. 1, a connector 1 according to the present embodiment is used to electrically connect electric components such as between a power supply and a device, or between a device and a device. The connector 1 has a first housing 3 and a second housing 5 which can be fitted. In the first housing 3, for example, a first terminal (not illustrated) electrically connected to one electric component is arranged. In the second housing 5, for example, a second terminal (not illustrated) electrically connected to the other electric component is arranged. In the connector 1, when the first housing 3 and the second housing 5 are fitted into each other, the first terminal and the second terminal are electrically connected to each other, thereby electrically connecting the electric components to each other.

As illustrated in FIGS. 1 to 6, the connector 1 includes the first housing 3 and the second housing 5.

As illustrated in FIGS. 1, 2, and 6, the first housing 3 is made of an insulating material such as synthetic resin, for example. The first housing 3 is formed in a rectangular parallelepiped housing shape such that an upper wall 7, a lower wall 9 and a pair of side walls 11 and 11 are continuous and such that the second housing 5 can be fitted into the first housing 3. The front side in the fitting direction between the first housing 3 and the second housing 5 is opened in such a way that the second housing 5 can be inserted therein. The rear side in the fitting direction between the first housing 3 and the second housing 5 is closed by a bottom wall 13 that is formed of one member continuous with the upper wall 7, the lower wall 9, and the pair of side walls 11 and 11. The bottom wall 13 of the first housing 3 is provided with a first arrangement portion 15, which pass through the bottom wall 13, in which a tab-like first connection portion (not illustrated) of the first terminal is arranged. A plurality of first arrangement portions 15 (here, seven) are provided at a predetermined spacing along a direction orthogonal to the fitting direction between the first housing 3 and the second housing 5.

A partition portion 17 is provided above the first arrangement portion 15. The partition portion 17 is formed of one member continuous with the upper wall 7 and the bottom wall 13, and project inwardly. A plurality of partition portions 17 (here, seven) are provided at a position corresponding to each of the first arrangement portions 15. The partition portions 17 extend from the bottom wall 13 to an opening along the fitting direction between the first housing 3 and the second housing 5. The pair of side walls 11 and 11 of the first housing 3 are provided with respective movement restriction portions 19 which are formed of one member continuous with the pair of side walls 11 and 11 and the bottom wall 13, and project inwardly. The movement restriction portions 19 extend from the bottom wall 13 to an opening along the fitting direction between the first housing 3 and the second housing 5. The pair of side walls 11 and 11 and the lower wall 9 of the first housing 3 are provided with respective supporting portions 21 which are formed of one member continuous with the pair of side walls 11 and 11, the lower wall 9, and the bottom wall 13, and project inwardly. The supporting portions 21 extend from the bottom wall 13 to an opening along the fitting direction between the first housing 3 and the second housing 5.

As illustrated in FIGS. 1 and 3 to 6, the second housing 5 is made of an insulating material such as synthetic resin, for example. The second housing 5 is formed in a U-shaped housing shape with an upper opening such that a lower wall 23 and a pair of side walls 25 and 25 are continuous and such that the second housing 5 can be fitted into the first housing 3. A space partitioned by the lower wall 23 and the pair of side walls 25 and 25 of the second housing 5 forms a second arrangement portion 27 capable of accommodating the second terminal. The second terminal has a box shape into which the first connection portion of the first terminal can be inserted, or a second connection portion (not illustrated) constituted of a pair of holding pieces for holding the first connection portion, and is electrically connected to a terminal portion of an electric wire (not illustrated) which is electrically connected to an electric component.

The front side of the second arrangement portion 27 in the fitting direction with the first housing 3 is closed by a bottom wall 29 that is formed of one member continuous with the pair of side walls 25 and 25. A hole through which the first connection portion can be inserted is formed in the bottom wall 29 at a position corresponding to the first arrangement portion 15 so as to pass through the bottom wall 29. The height of the bottom wall 29 directed upward from the lower wall 23 is set lower than the height of the pair of side walls 25 and 25 directed upward from the lower wall 23 such that the partition portion 17 can be arranged between the pair of side walls 25 and 25 and the bottom wall 29. The partition portion 17 which is arranged between the pair of side walls 25 and 25 and the bottom wall 29 restricts the movement of the second housing 5 with respect to the first housing 3, thereby making it possible to stably hold the second housing 5 in the first housing 3. The rear side of the second arrangement portion 27 in the fitting direction with the first housing 3 is opened in such a way that an electric wire can be drawn out to the outside. Inside the second arrangement portion 27 is provided with an engaged portion formed of a hole or a groove that can be engaged with an engaging portion (not illustrated) provided in the second terminal. The engaged portion restricts the movement of the second terminal with respect to the second arrangement portion 27 by engaging with the engaging portion, thereby making it possible to stably hold the second terminal in the second arrangement portion 27.

The lower wall 23 of the second arrangement portion 27 is provided with an extension portion 31 extending downward from the outer surface at a position corresponding to the first arrangement portion 15 (hole in the bottom wall 29). The extension portion 31 is extended along the fitting direction between the first housing 3 and the second housing 5 so as to be divided into two or more (here, two) between the bottom wall 29, and the opening in the rear side in the fitting direction with the first housing 3. The extension portion 31 may be continuously extended without being divided along the fitting direction between the first housing 3 and the second housing 5. The lower surface of the extension portion 31 is arranged so as to face the inner surface of the lower wall 9 of the first housing 3. Since the extension portion 31 and the lower wall 9 are arranged so as to face each other, the movement of the second housing 5 with respect to the first housing 3 can be restricted, thereby making it possible to stably hold the second housing 5 in the first housing 3. When the second housing 5 is arranged inside the first housing 3 at both ends in the width direction, the movement restriction portions 19 are arranged so as to face the outer surface of the side walls 25, and the supporting portion 21 is arranged so as to face the outer surface of the lower wall 23. Since the side walls 25 and the movement restriction portions 19 are arranged so as to face each other, and the lower wall 23 and the supporting portion 21 are arranged so as to face other, the movement of the second housing 5 with respect to the first housing 3 can be restricted, thereby making it possible to stably hold the second housing 5 in the first housing 3.

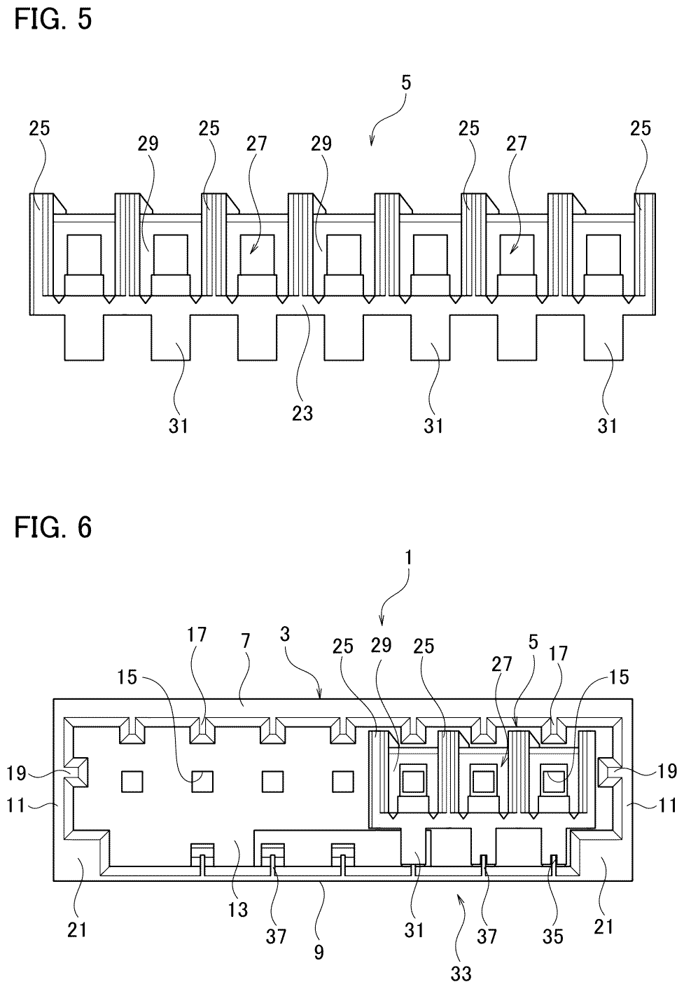

A plurality of second arrangement portions 27 (here, three) are continuously provided along a direction orthogonal to the fitting direction between the first housing 3 and the second housing 5 such that the adjacent side walls 25 and 25 and the lower walls 23 and 23 are continuous members. The second housing 5 having the plurality of second arrangement portions 27 is formed by processing (such as cutting or fusing) the second housing 5 (see FIG. 5) having the plurality of second arrangement portions 27 continuously provided (here, seven) according to an electric circuit to be applied. Since the second housing 5 is formed in this manner, only one die for molding the second housing 5 is required to be manufactured, thereby reducing the manufacturing cost of the second housing 5.

The second housing 5 having the plurality of second arrangement portions 27 (here, three) is fitted into a part where the plurality of first arrangement portions 15 (here, three) of the first housing 3 are positioned according to an electric circuit to be applied. Since the second housing 5 is fitted into the first housing 3 in this manner, the first terminal and the second terminal are electrically connected to each other, thereby forming a desired electric circuit.

Here, the plurality of second arrangement portions 27 (here, three) are less in number than the plurality of the first arrangement portions 15 (here, seven). For this reason, although the second housing 5 can be fitted into the first housing 3 at a free position, there is a possibility that the second housing 5 may be fitted into the first housing 3 at a different position. If the second housing 5 is fitted into the first housing 3 at a different position, a different first terminal and a different second terminals are electrically connected to each other, and thus a desired electric circuit cannot be acquired. Therefore, the first housing 3 and the second housing 5 are provided with a restriction portion 33 capable of enabling the first housing 3 and the second housing 5 to be fitted in a state in which the second arrangement portion 27 is arranged in a regular position with respect to the plurality of first arrangement portions 15.

As illustrated in FIGS. 1 to 4 and 6, the restriction portion 33 includes a groove 35 and a projection 37. As illustrated in FIG. 1, a state is illustrated in which the second housing 5 is fitted into the left end of the first housing, and in the following description, this state will be described as a state in which the second arrangement portion 27 is arranged in a regular position with respect to the plurality of first arrangement portions 15.

The groove 35 is provided in the second housing 5. The groove 35 is provided in the lower surface of the extension portion 31 which is positioned below the lower wall 23 of the second arrangement portion 27 so as to be positioned corresponding to the second arrangement portion 27 of the second housing 5. The groove 35 is provided over the whole length direction of the lower surface of the extension portion 31 so as to be along the fitting direction between the first housing 3 and the second housing 5. The groove 35 is opened at least in the front side in the fitting direction between the first housing 3 and the second housing 5 such that the projection 37 can be inserted when the first housing 3 and the second housing 5 are fitted into each other. Here, the groove 35 is also opened in the rear side in the fitting direction between the first housing 3 and the second housing 5, thereby making it possible to visually confirm the insertion state of the projection 37 into the groove 35. Since the groove 35 is provided along the fitting direction between the first housing 3 and the second housing 5, it is possible to guide the first housing 3 and the second housing 5 to be fitted.

The groove 35 is provided in the second housing 5 at a position corresponding to the second arrangement portion 27 (here, the second arrangement portion 27 at the center and the right end) other than one second arrangement portion 27 (here, the second arrangement portion 27 at the left end) among the plurality of second arrangement portions 27 (here, three). The groove 35 may be provided in the second housing 5 at a position corresponding to the second arrangement portion 27 other than at least one second arrangement portion 27. For example, the groove 35 may be provided in the second housing 5 at a position corresponding to only the second arrangement portion 27 at the right end, and the groove 35 may not be provided at a position corresponding to the other second arrangement portions 27.

The projection 37 is provided on the first housing 3. The projection 37 is provided on the inner surface of the lower wall 9 which is positioned below the first arrangement portion 15 so as to be positioned corresponding to the first arrangement portion 15 of the first housing 3. The projection 37 is formed by one member continuous with the lower wall 9 so as to project from the inner surface of the lower wall 9 toward the first arrangement portion 15. The projecting height of the projection 37 is set equal to or slightly smaller than the depth of the groove 35. The width of the projection 37 is set equal to or slightly smaller than the width of the groove 35. The projection 37 extends over the whole area from the bottom wall 13 to the opening of the first housing 3 along the fitting direction between the first housing 3 and the second housing 5. Therefore, at least a part of the projection 37 is arranged on the front side in the fitting direction between the first housing 3 and the second housing 5 (the opening side in the first housing 3). Since the projection 37 is arranged on the front side in the fitting direction between the first housing 3 and the second housing 5, it is possible to detect whether or not the projection 37 is inserted into the groove 35 at the initial stage of the fitting between the first housing 3 and the second housing 5. By extending the projection 37 along the fitting direction between the first housing 3 and the second housing 5, the engagement range between the groove 35 and the projection 37 can be enlarged, thereby making it possible to stably maintain the fitting state between the first housing 3 and the second housing 5.

In the first housing 3, the projection 37 is provided at a position corresponding to all of the first arrangement portions 15 (here, four) in which the second arrangement portion 27 is not arranged among the plurality of first arrangement portions 15 (here, seven). In the first housing 3, the projection 37 is provided at a position corresponding to the first arrangement portion 15 (here, the first arrangement portion 15 at the center and right end) in which the second arrangement portion 27 corresponding to the groove 35 is arranged among the plurality of first arrangement portions 15 (here, three) in which the second arrangement portion 27 is arranged. That is, the projection 37 is provided in the first housing 3 at a position corresponding to all of the first arrangement portions 15 other than the first arrangement portion 15 (here, the first arrangement portion 15 at the left end) in which the second arrangement portion 27 not corresponding to the groove 35 is arranged among the plurality of first arrangement portions 15.

When the first housing 3 and the second housing 5 are fitted into each other, the restriction portion 33 can detect whether or not the first housing 3 and the second housing 5 can be fitted into each other according to whether or not the projection 37 can be inserted into the groove 35. When the second arrangement portion 27 is arranged in a regular position with respect to the plurality of first arrangement portions 15 (see FIG. 1), the position of the projection 37 coincides with the position of the groove 35, thereby enabling the projection 37 to be inserted into the groove 35. Therefore, the first housing 3 and the second housing 5 can be fitted into each other, and a regular first terminal and a regular second terminal can be electrically connected to each other, and thus a desired electric circuit can be acquired. In contrast, when the second arrangement portion 27 is not arranged in a regular position with respect to the plurality of first arrangement portions 15 (see FIG. 6), the position of the projection 37 does not coincide with the position of the groove 35, and thus the projection 37 cannot be inserted into the groove 35. Here, the extension portion 31 at the left end in which the groove 35 is not provided abuts the projection 37, and thus the projection 37 cannot be inserted into the groove 35. Therefore, the first housing 3 and the second housing 5 cannot be fitted into each other, and thus a different first terminal and a different second terminal are not electrically connected to each other.

The connector 1 includes the first housing 3 provided with the plurality of first arrangement portions 15 in which a plurality of first terminals are arranged. The connector 1 further includes the second housing 5 fitted into the first housing 3 and provided with the second arrangement portion 27, which is provided less in number than the plurality of first arrangement portions 15, in which a second terminal to be electrically connected to the first terminal is arranged. Further, the first housing 3 and the second housing 5 are provided with a restriction portion 33 which enables the first housing 3 and the second housing 5 to be fitted in a state in which the second arrangement portion 27 is arranged in a regular position with respect to the plurality of first arrangement portions 15.

When the second arrangement portion 27 is arranged in a regular position with respect to the plurality of first arrangement portions 15, the restriction portion 33 enables the first housing 3 and the second housing 5 to be fitted. Therefore, a regular first terminal and a regular second terminal can be electrically connected to each other, and thus a desired electric circuit can be acquired. In contrast, the restriction portion 33 makes it impossible for the first housing 3 and the second housing 5 to be fitted when the second arrangement portion 27 is not arranged in a regular position with respect to the plurality of first arrangement portions 15. Therefore, a different first terminal and a different second terminal are not electrically connected to each other.

Accordingly, in the connector 1, the second housing 5 can be fitted into the first housing 3 in a regular position.

Further, the restriction portion 33 has the groove 35 provided in the second housing 5, and the projection 37 provided in the first housing 3, and insertable into the groove 35 in a state in which the second arrangement portion 27 is arranged in a regular position with respect to the plurality of first arrangement portions 15.

When the second arrangement portion 27 is arranged in a regular position with respect to the plurality of first arrangement portions 15, the restriction portion 33 can insert the projection 37 into the groove 35, thereby enabling the first housing 3 and the second housing 5 to be fitted. In contrast, when the second arrangement portion 27 is not arranged in a regular position with respect to the plurality of first arrangement portions 15, the restriction portion 33 cannot insert the projection 37 into the groove 35, thereby making it difficult for the first housing 3 and the second housing 5 to be fitted. Therefore, whether or not the second arrangement portion 27 is arranged in a regular position with respect to the plurality of first arrangement portions 15 can be detected according to whether or not the projection 37 can be inserted into the groove 35 in the restriction portion 33.

Further, a plurality of second arrangement portions 27 are provided in the second housing 5. In addition, the groove 35 is provided in the second housing 5 at a position corresponding to the second arrangement portion 27 other than at least one second arrangement portion 27 among the plurality of second arrangement portions 27. The projection 37 is provided in the first housing 3 at a position corresponding to the first arrangement portion 15 in which the second arrangement portion 27 not corresponding to the groove 35 is not arranged among the plurality of first arrangement portions 15.

When the plurality of second arrangement portions 27 are arranged in a regular position with respect to the plurality of first arrangement portions 15, the second arrangement portion 27 not corresponding to the groove 35 is arranged in the first arrangement portion 15 not corresponding to the projection 37. In addition, the second arrangement portion 27 corresponding to the groove 35 is arranged in the first arrangement portion 15 corresponding to the projection 37. Therefore, the projection 37 can be inserted into the groove 35, and thus the first housing 3 and the second housing 5 can be fitted into each other. In contrast, when the plurality of second arrangement portions 27 are not arranged in a regular position with respect to the plurality of first arrangement portions 15, the second arrangement portion 27 not corresponding to the groove 35 is arranged in the first arrangement portion 15 corresponding to the projection 37. Therefore, the projection 37 cannot be inserted into the groove 35, and thus the first housing 3 and the second housing 5 cannot be fitted into each other. Accordingly, whether or not the plurality of second arrangement portions 27 are arranged in a regular position with respect to the plurality of first arrangement portions 15 can be detected according to whether or not the projection 37 can be inserted into the groove 35 in the restriction portion 33.

Further, the groove 35 is opened in the front side in the fitting direction between the first housing 3 and the second housing 5, and is provided along the fitting direction between the first housing 3 and the second housing 5. The projection 37 is provided on the front side in the fitting direction between the first housing 3 and the second housing 5.

Thus, it is possible to detect whether or not the projection 37 is inserted into the groove 35 at the initial stage of the fitting between the first housing 3 and the second housing 5. Since the groove 35 is provided along the fitting direction between the first housing 3 and the second housing 5, it is possible to guide the first housing 3 and the second housing 5 to be fitted in a state in which the projection 37 is inserted into the groove 35.

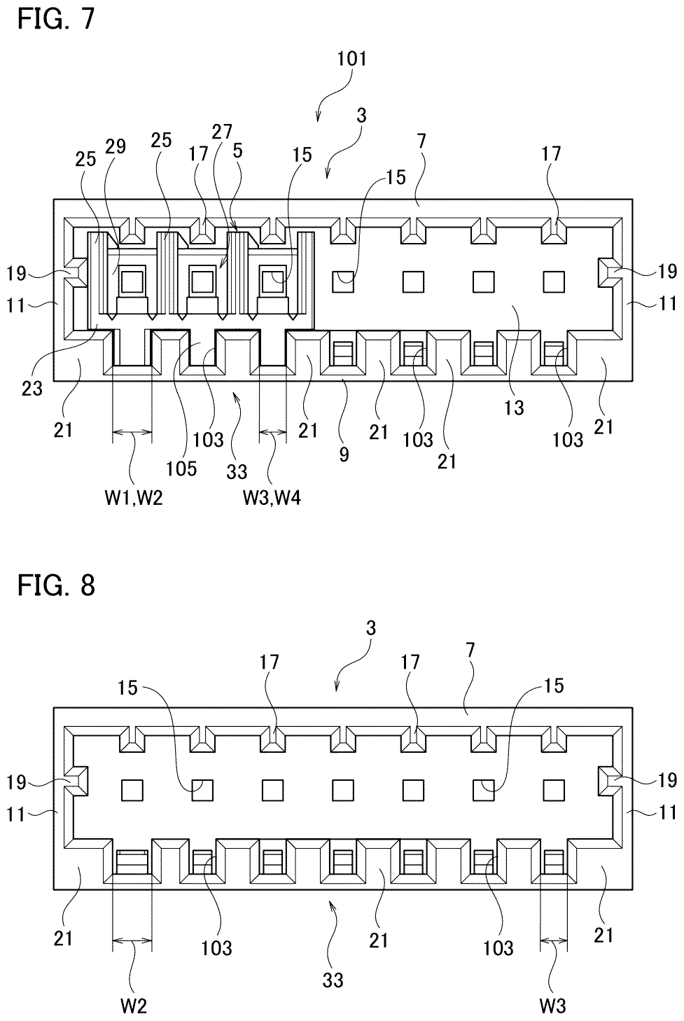

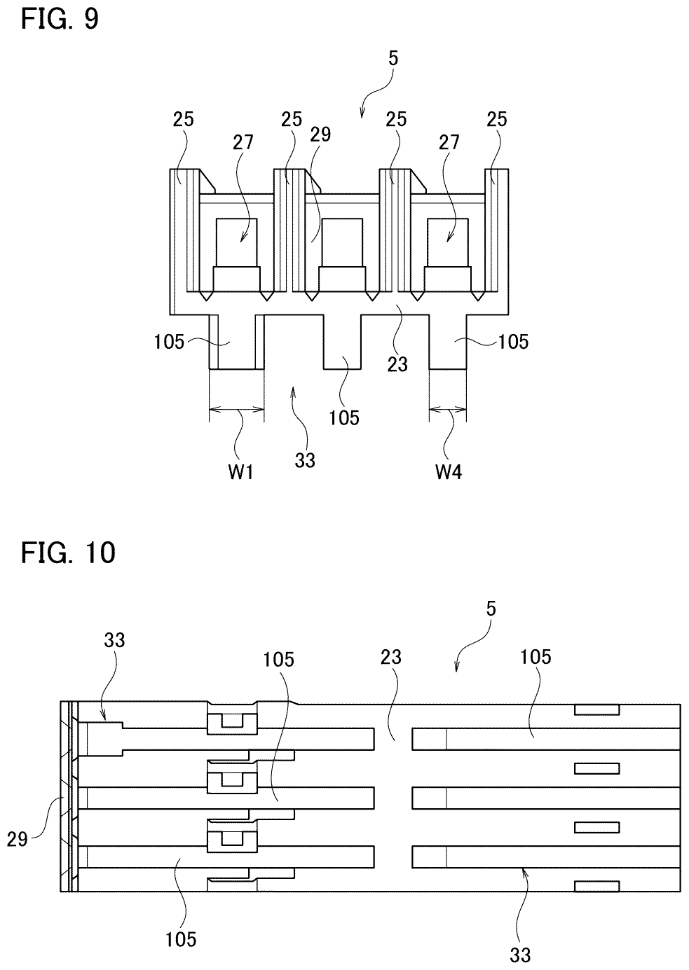

A second embodiment will be described with reference to FIGS. 7 to 15.

In a connector 101 according to a present embodiment, a groove 103 is provided in a first housing 3 at a position corresponding to a plurality of first arrangement portions 15. A projection 105 is provided in a second housing 5 at a position corresponding to a second arrangement portion 27. A width W1 of the projection 105 corresponding to the second arrangement portion 27 and a width W2 of the groove 103 corresponding to a first arrangement portion 15 in which the second arrangement portion 27 is arranged are set larger than a width W3 of the other groove 103.

Note that the same reference numerals are used to designate the same components as those of the first embodiment, and the description of the configuration and the function will be omitted by referring to the description in the first embodiment. However, since the configuration is the same as that of the first embodiment, the effect thus obtained is the same.

As illustrated in FIG. 7, a state is illustrated in which the second housing 5 is fitted into the left end of the first housing, and in the following description, this state will be described as a state in which the second arrangement portion 27 is arranged in a regular position with respect to the plurality of first arrangement portions 15.

As illustrated in FIGS. 7, 8, and 11, a lower wall 9 of the first housing 3 is provided with a plurality of supporting portions 21 (here, six) at a predetermined spacing between the supporting portions 21 and 21 respectively provided on the pair of side walls 11 and 11. The plurality of supporting portions 21 positioned between the supporting portions 21 and 21 on the pair of side walls 11 and 11 are formed of one member continuous with the lower wall 9 and the bottom wall 13, and project inwardly so as to have the same projecting height as that of the supporting portions 21 on the side walls 11 and 11. In addition, as with the supporting portions 21 on the side walls 11 and 11, the plurality of supporting portions 21 extend from the bottom wall 13 to the opening in the fitting direction between the first housing 3 and the second housing 5. In the first housing 3, the plurality of supporting portions 21 are provided between the plurality of first arrangement portions 15 (here, seven) or at positions corresponding to the outside in the arrangement direction. A space partitioned by the plurality of supporting portions 21 and the lower wall 9 forms the groove 103.

A plurality of grooves 103 (here, seven) are provided in the first housing 3 at positions corresponding to all of the first arrangement portions 15 (here, seven) among a plurality of first arrangement portions 15. The grooves 103 are provided along the fitting direction between the first housing 3 and the second housing 5. The grooves 103 are opened in the front side (opening side in the first housing 3) in the fitting direction between the first housing 3 and the second housing 5) such that the projections 105 can be inserted when the first housing 3 and the second housing 5 are fitted into each other. Since the grooves 103 are provided along the fitting direction between the first housing 3 and the second housing 5, it is possible to guide the first housing 3 and the second housing 5 to be fitted.

Of the plurality of first arrangement portions 15, at least one width W2 of a plurality of grooves 103 (here, three) positioned corresponding to the first arrangement portion 15 in which a plurality of second arrangement portions 27 (here, three) are arranged is set larger than the width W3 of the other grooves 103. Here, the width W2 of one groove 103 positioned at the left end is set larger than the width W3 of the other six grooves 103. Of the three grooves 103, all the grooves 103 may be set to the width W2, or two grooves 103 may be set to the width W2.

As illustrated in FIGS. 7 and 9 to 11, the lower wall 23 positioned corresponding to each of the second arrangement portions 27 (here, three) of the second housing 5 is provided with the projection 105 extending downward from the outer surface at a position corresponding to the first arrangement portion 15 (hole in the bottom wall 29). For this reason, the plurality of projections 105 (here, three) are provided in the second housing 5 at a position corresponding to each of the second arrangement portions 27 among the plurality of second arrangement portions 27 (here, three). The projecting height of the projection 105 is set equal to or slightly smaller than the depth of the groove 103. The projection 105 is extended along the fitting direction between the first housing 3 and the second housing 5 so as to be divided into two or more (here, two) between the bottom wall 29 and the opening in the rear side in the fitting direction of the first housing 3. The projection 105 may be continuously extended without being divided along the fitting direction between the first housing 3 and the second housing 5. At least a part of the projection 105 is arranged on the front side in the fitting direction between the first housing 3 and the second housing 5 (the bottom wall 29 side of the second housing 5). Since the projection 105 is arranged on the front side in the fitting direction between the first housing 3 and the second housing 5, it is possible to detect whether or not the projection 105 is inserted into the groove 103 at the initial stage of the fitting between the first housing 3 and the second housing 5. By extending the projection 105 along the fitting direction between the first housing 3 and the second housing 5, the engagement range between the groove 103 and the projection 105 can be enlarged, thereby making it possible to stably maintain the fitting state between the first housing 3 and the second housing 5.

Of the plurality of second arrangement portions 27, the width W1 of the projection 105 (here, the projection 105 at the left end), corresponding to the second arrangement portion 27, which is arranged in the first arrangement portion 15 corresponding to the wide groove 103 is set larger than the width W4 of the other projection 105. The portion of the projection 105 as serving as the width W1 is provided only on the front side (the bottom wall 29 side) in the fitting direction between the first housing 3 and the second housing 5. Since the width W1 of the projection 105 is set only to the front side in the fitting direction between the first housing 3 and the second housing 5, it is possible to detect whether the projection 105 is inserted into the groove 103 at the initial stage of the fitting between the first housing 3 and the second housing 5. In addition, the material amount used for the projection 105 can be reduced, thereby reducing the weight and cost. The width W1 of the projection 105 is set equal to or slightly smaller than the width W2 of the groove 103, and is set larger than the width W3 of the groove 103. The width W4 of the projection 105 is set equal to or slightly smaller than the width W3 of the groove 103. Therefore, the projection 105 having the width W1 can be inserted into the groove 103 having the width W2, but cannot be inserted into the groove 103 having the width W3. The projection 105 having the width W4 can be inserted into both the groove 103 having the width W2 and the groove 103 having the width W3. The projection 105 having the width W1 may be provided corresponding to the second arrangement portion 27 which is arranged in the first arrangement portion 15 positioned corresponding to the groove 103 having the width W2.

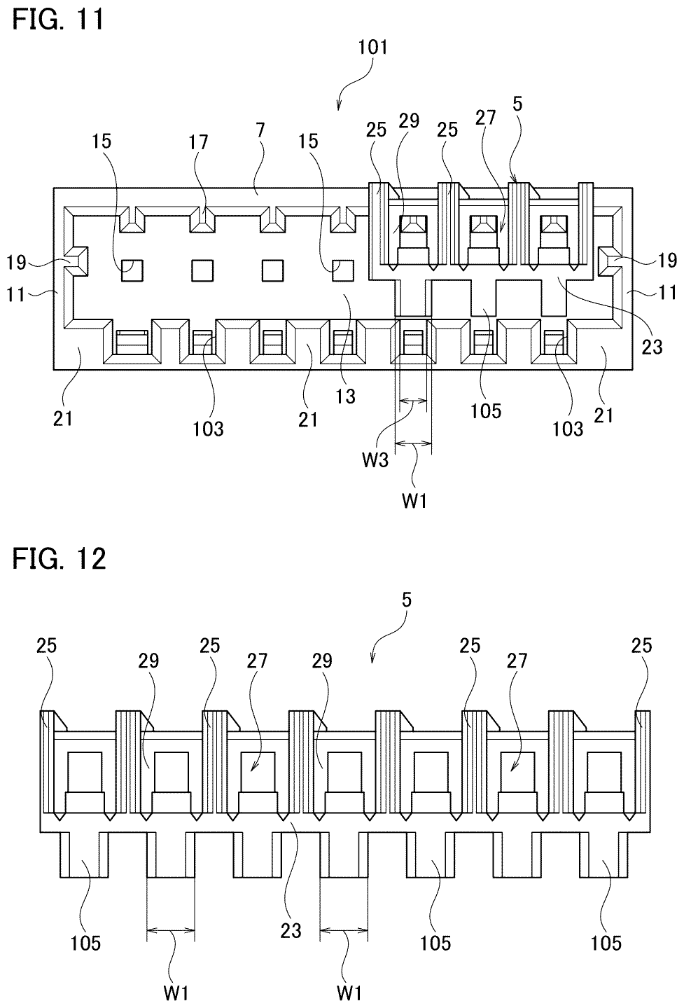

When the first housing 3 and the second housing 5 are fitted into each other, the restriction portion 33 having the groove 103 and the projection 105 can detect whether or not the first housing 3 and the second housing 5 can be fitted into each other according to whether or not the projection 105 can be inserted into the groove 103. When the second arrangement portion 27 is arranged in a regular position with respect to the plurality of first arrangement portions 15 (see FIG. 7), the position of the projection 105 having the width W1 coincide with the position of the groove 103 having the width W2, thereby enabling the projection 105 to be inserted into the groove 103. At this time, the position of the projection 105 having the width W4 also coincides with the position of the groove 103 having the width W3, thereby enabling the projection 105 to be inserted into the groove 103. Therefore, the first housing 3 and the second housing 5 can be fitted into each other, and a regular first terminal and a regular second terminal can be electrically connected to each other, and thus a desired electric circuit can be acquired. In contrast, when the second arrangement portion 27 is not arranged in a regular position with respect to the plurality of first arrangement portions 15 (see FIG. 11), the projection 105 having the width W1 is arranged in the groove 103 having the narrow width W3, and thus the projection 105 cannot be inserted into the groove 103. Therefore, the first housing 3 and the second housing 5 cannot be fitted into each other, and thus a different first terminal and a different second terminal are not electrically connected to each other.

Here, as illustrated in FIG. 12, the second housing 5 is formed by processing (such as cutting or fusing) the second housing 5 having a plurality of second arrangement portions 27 continuously provided (here, seven) according to an electric circuit to be applied. In the projections 105 provided in the second housing 5 illustrated in FIG. 12, all of the projections 105 (here, seven) are formed in such a way that the projections 105 have the width W1 on the front side (the bottom wall 29 side) in the fitting direction between the first housing 3 and the second housing 5. According to the electric circuit to be applied, the projection 105 can be made to have the width W4 by removing a portion of the projection 105 that is the width W1 other than the projection 105 which should have the width W1 from among the plurality of projections 105 of the divided second housing 5. Since the second housing 5 is formed in this manner, only one die for molding the second housing 5 is required to be manufactured, thereby reducing the manufacturing cost of the second housing 5.

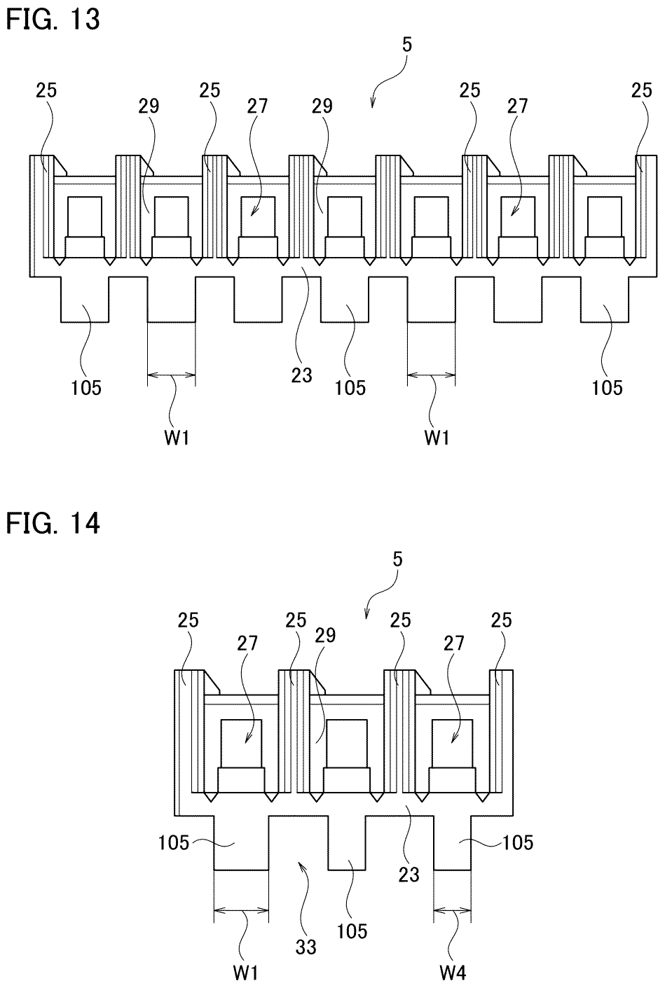

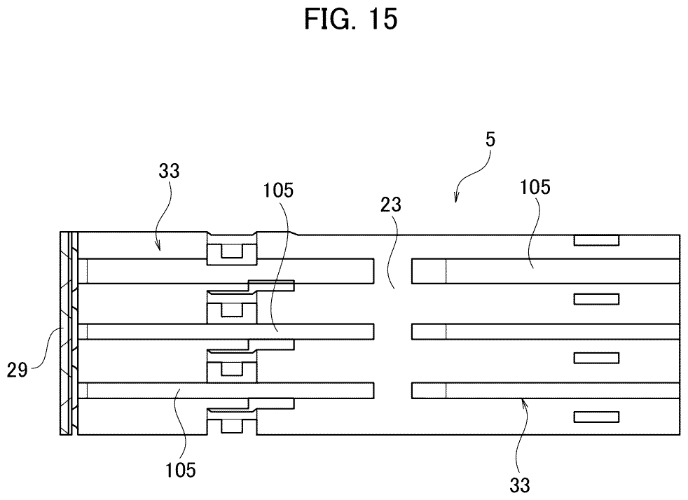

As illustrated in FIG. 13, the second housing 5 may be formed by processing (such as cutting or fusing) the second housing 5 having the plurality of second arrangement portions 27 continuously provided (here, seven) according to an electric circuit to be applied. The projections 105 provided on the second housing 5 illustrated in FIG. 13 are formed such that all of the projections 105 (here, seven) have the width W1 in the whole length direction along the fitting direction between the first housing 3 and the second housing 5. As illustrated in FIGS. 14 and 15, the second housing 5 having a plurality of projections 105 (here, three) is formed by dividing the second housing 5 illustrated in FIG. 13 according to an electric circuit to be applied. The projection 105 can be made to have the width W4 by removing a portion of the projection 105 that is the width W1 other than the projection 105 which should have the width W1 from among the plurality of projections 105 of the divided second housing 5. Since the second housing 5 is formed in this manner, only one die for molding the second housing 5 is required to be manufactured, thereby reducing the manufacturing cost of the second housing 5. Incidentally, the second housing 5 illustrated in FIG. 12 has fewer portions to be removed when removing the projections 105, and thus the manufacturing cost can be reduced.

In such a connector 101, the groove 103 is provided in the first housing 3 at a position corresponding to the plurality of first arrangement portions 15. The projection 105 is provided in the second housing 5 at a position corresponding to the second arrangement portion 27. The width W1 of the projection 105 corresponding to the second arrangement portion 27 and the width W2 of the groove 103 corresponding to the first arrangement portion 15 in which the second arrangement portion 27 is arranged are set larger than the width W3 of the other groove 103.

When the second arrangement portion 27 is arranged in a regular position with respect to the plurality of first arrangement portions 15, the position of the projection 105 having the width W1 and the position of the groove 103 having the width W2 coincide with each other, thereby enabling the projection 105 to be inserted into the groove 103. In contrast, when the second arrangement portion 27 is not arranged in a regular position with respect to the plurality of first arrangement portions 15, the projection 105 having the width W1 is arranged in the groove 103 having the narrow width W3, and thus the projection 105 cannot be inserted into the groove 103. Therefore, whether or not the plurality of second arrangement portions 27 are arranged in a regular position with respect to the plurality of first arrangement portions 15 can be detected according to whether or not the projection 105 can be inserted into the groove 103 in the restriction portion 33.

Although the present embodiment has been described above, the present embodiment is not limited to the above description, and various modifications can be made within the gist of the present embodiment.

For example, in the connector according to the first embodiment, the projection is provided in the first housing and the groove is provided in the second housing; however, the present embodiment is not limited thereto, and the groove may be provided in the first housing and the projection may be provided in the second housing. In this case, for example, one projection may be provided on the outer surface of the second housing, and one groove may be provided in the inner surface of the first housing into which the projection can be inserted when the second arrangement portion is arranged in a regular position with respect to the plurality of first arrangement portions.

Further, although the number of first arrangement portions provided in the first housing is seven, the present embodiment is not limited thereto. For example, the number of first arrangement portions may be six or less, or eight or more. In addition, although the number of second arrangement portions provided in the second housing is three, the present embodiment is not limited thereto. For example, the number of second arrangement portions may be two or less, or four or more. In this case, the number of second arrangement portions provided in the second housing may be fewer than the number of first arrangement portions.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

1. A connector, comprising:
a first housing provided with a plurality of first arrangement portions in which a plurality of first terminals are arranged; and
a second housing fitted into the first housing and provided with a second arrangement portion, which is provided less in number than the plurality of first arrangement portions, in which a second terminal to be electrically connected to the first terminal is arranged, wherein
the first housing and the second housing are provided with a restriction portion which enables the first housing and the second housing to be fitted in a state in which the second arrangement portion is arranged in a regular position with respect to the plurality of first arrangement portions.

2. The connector according to claim 1, wherein
the restriction portion has a groove provided in one of the first housing and the second housing, and a projection provided in the other of the first housing and the second housing, and insertable into the groove in a state in which the second arrangement portion is arranged in a regular position with respect to the plurality of first arrangement portions.

3. The connector according to claim 2, wherein
a plurality of second arrangement portions are provided in the second housing,
the groove is provided in the second housing at a position corresponding to the second arrangement portion other than at least one second arrangement portion among the plurality of second arrangement portions, and
the projection is provided in the first housing at a position corresponding to the first arrangement portion in which the second arrangement portion not corresponding to the groove is not arranged among the plurality of first arrangement portions.

4. The connector according to claim 2, wherein
the groove is provided in the first housing at a position corresponding to the plurality of first arrangement portions,
the projection is provided in the second housing at a position corresponding to the second arrangement portion, and
a width of the projection corresponding to the second arrangement portion and a width of the groove corresponding to the first arrangement portion in which the second arrangement portion is arranged are set larger than a width of the other groove.

5. The connector according to claim 2, wherein
the groove is opened in a front side in a fitting direction between the first housing and the second housing, and is provided along the fitting direction between the first housing and the second housing, and
the projection is provided on the front side in the fitting direction between the first housing and the second housing.
